(19) United States
(12) Patent Application Publication
(10) Pub. No.: US 2012/0101859 A1
(43) Pub. Date: Apr. 26, 2012

(54) ONLINE RESERVATION SOFTWARE

(76) Inventors: William Boulton, Lousana (CA); Ely Felice, Edmonton (CA)

(21) Appl. No.: 13/378,859

(22) PCT Filed: Jun. 16, 2010
(86) PCT No.: PCT/CA10/00906

§ 371 Date: Dec. 16, 2011

Related U.S. Application Data
(60) Provisional application No. 61/187,399, filed on Jun. 16, 2009.

(51) Int. Cl. G06Q 10/02

(52) U.S. Cl. 705/5

(57) ABSTRACT

An online reservation system, characterized by a transient reservation status of “pending” having an associated time limit. An inquiry on a specific one of the resources via the user interface triggers the pending status for the specific one of the resources and blocks other users from reserving the specific one of the resources for the associated time limit. The reservation status of the specific one of the resources is updated to “reserved” if payment is effected within the associated time limit. The reservation status of the specific one of the resources is updated to “unreserved” if payment is not effected within the associated time limit.

### FIELD

There is described an online reservation system where individuals may reserve resources, such as seats to an event.

### BACKGROUND

United States patent publication no. 2006/0031105 (Lee et al.) describes a reservation system that provides real time availability of the resources. United States patent publication no. 2006/0230433 (Chang) describes a system that allows a user to inquire on a resources usage status of a particular device. Examples of companies that provide online reservation software include Globeres (www.globeres.com) and OnRes http://www.onressystems.com/). A possible weakness of these systems is when multiple users are attempting to reserve the same resource, such as the same seat to an event.

### SUMMARY

According to one aspect there is provided an online reservation system with a server connected to a network having a database storing reservation information for reservable resources. The reservation information includes time, location, pricing and reservation status. The reservation status lists the resources as being “unreserved” or “reserved”. A user interface is provided for submitting queries and receiving responses and a payment system is provided for effecting payments. The online reservation system is characterized by a transient reservation status of “pending” having an associated time limit. An inquiry on a specific one of the resources via the user interface triggers the pending status for the specific one of the resources and blocks other users from reserving the specific one of the resources for the associated time limit. The reservation status of the specific one of the resources is updated to “reserved” if payment is effected within the associated time limit. The reservation status of the specific one of the resources is updated to “unreserved” if payment is not effected within the associated time limit.

According to another aspect there is provided a method for making online reservations of reservable resources in an online reservation system with a server connected to a network having a database storing reservation information for reservable resources. The reservation information includes time, location, pricing and reservation status. The reservation status lists the resources as being “unreserved” or “reserved”. A user interface is provided for submitting queries and receiving responses and a payment system is provided for effecting payments. The method includes triggering a transient reservation status of “pending” having an associated time limit when an inquiry on a specific one of the resources is made via the user interface. This pending status is visible through the user interface and serves to block other users from reserving the specific one of the resources. The method also includes a step of updating the reservation status of the specific one of the resources to “reserved” if payment is effected within the associated time limit. The method further includes a step of updating the reservation status of the specific one of the resources to “unreserved” if payment is not effected within the associated time limit.

With the online reservation system described above and associated method, the first user to make an inquiry on a specific resource triggers a change to “pending” status that blocks other users and is visible to the user interface. This prevents problems arising when two or more users attempt to reserve the same specific resource. It also avoids user frustration where reserved and unreserved status is changing rapidly in real time. The user knows that the resource is avail for a limited time duration while they complete their transaction. For example, the time duration may be set at five minutes.

In addition to the reservation status of “pending”, there are other supplemental indications of reservation status that can improve the operation of the online reservation system. Beneficial results may be obtained when the reservation status includes a status of “unavailable” for any of the resources that are unavailable for reservation through the user interface. For example, there are some events at which seats are physically present, but unavailable as they are needed to locate the staging or their sight lines are obscured by the staging. Beneficial results may also be obtained when the reservation status includes a status of “group block” listing resources that are allocated to a specific group. The resources in the group block are only available for reservation through the user interface to authorized members of the specific group.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1A through 1D is a flow chart of an online reservation system from the business coordinator perspective.

FIG. 2 is an example of a calendar display of availability.

FIG. 3 is an example of the layout of a venue

FIG. 4 is an example of a chart showing seat availability

FIG. 5A through 5D is a flow chart of an online reservation system from the customer perspective.

### DETAILED DESCRIPTION

An online reservation system will now be described with reference to the Figures. The description will begin with a discussion of the Promoters perspective, and then will describe the method from the customer perspective. While the preferred embodiment is described with respect to a concert in a music venue, it will be understood that the principles may also be applied to other online booking systems, such as flights, hotels, campgrounds, office space, and the like. It will also be understood that the description is of a preferred embodiment, and that certain features and steps or certain workflows may not be desirable or applicable for all situations.

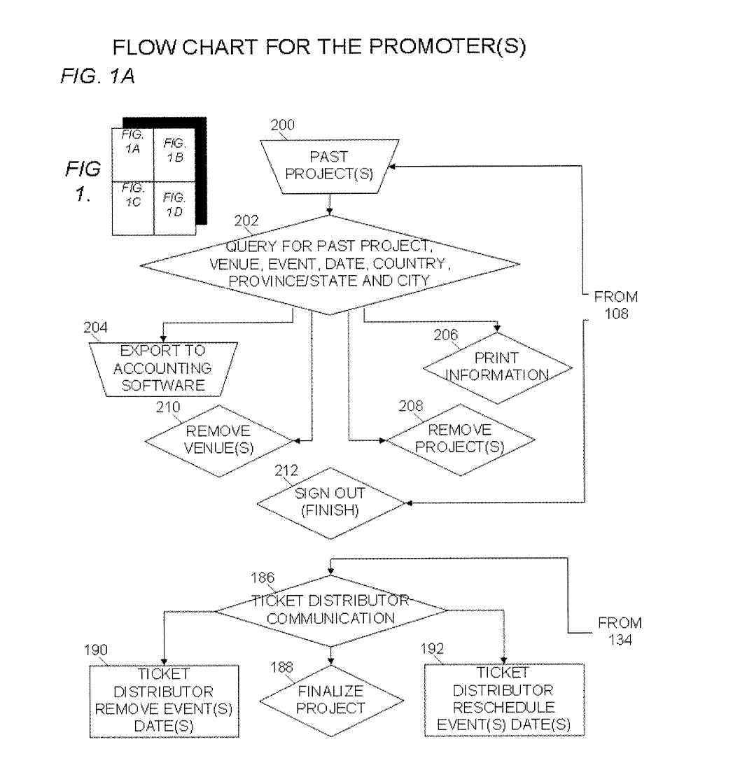

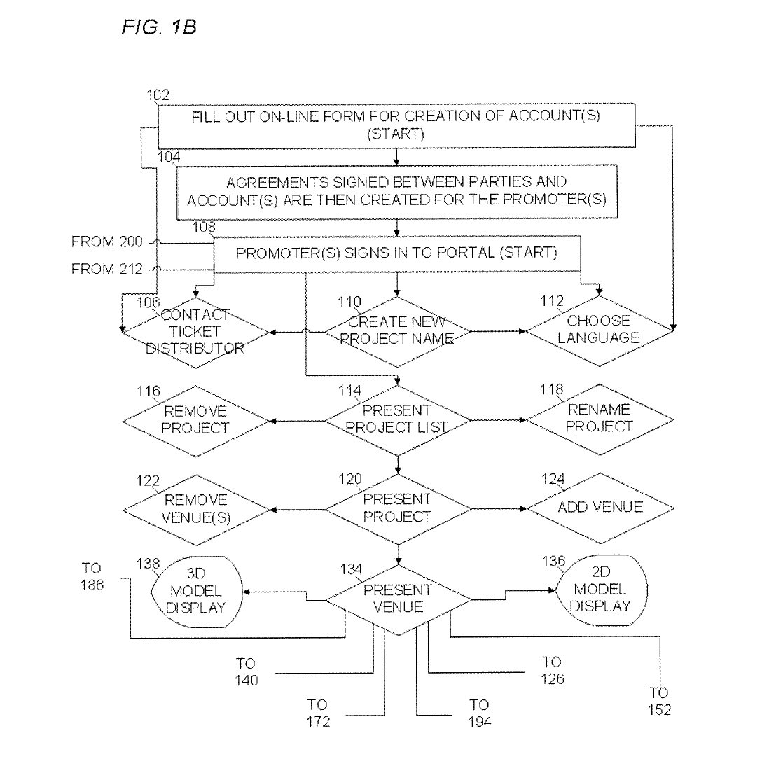

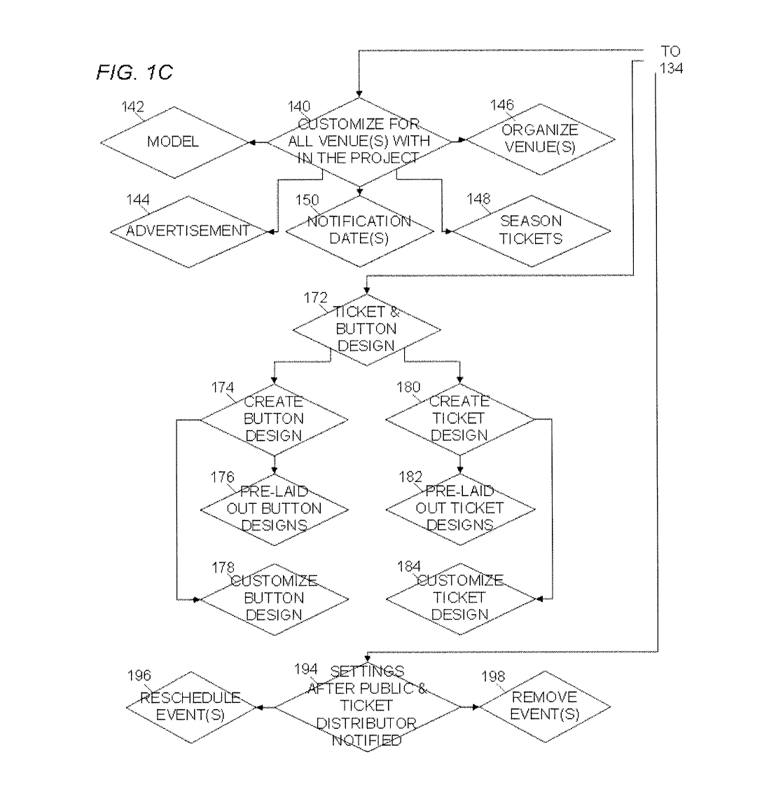

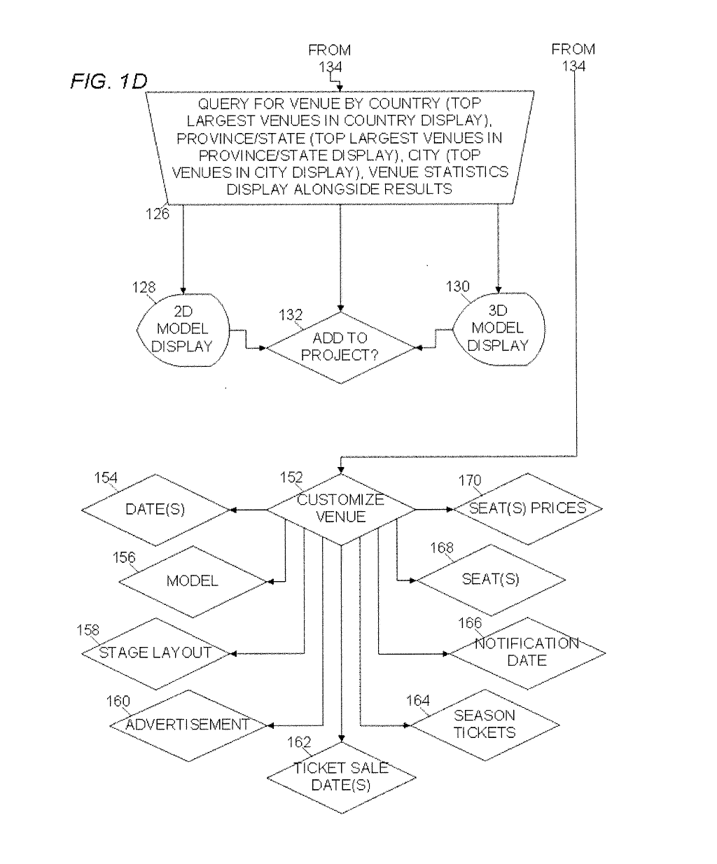

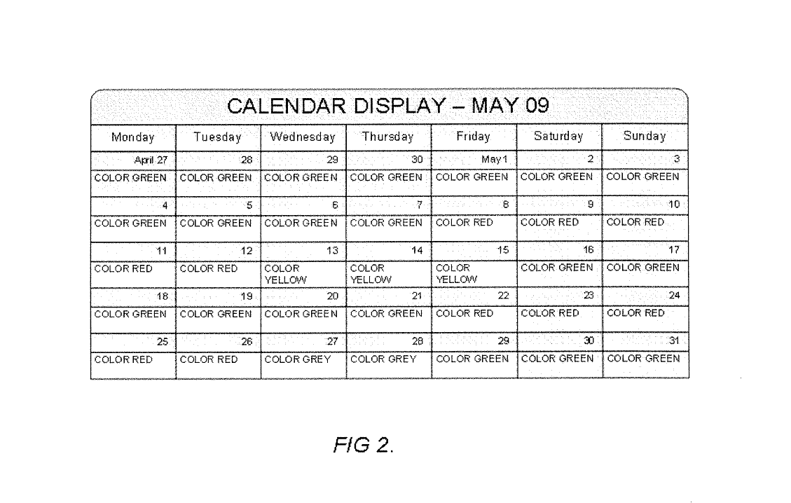

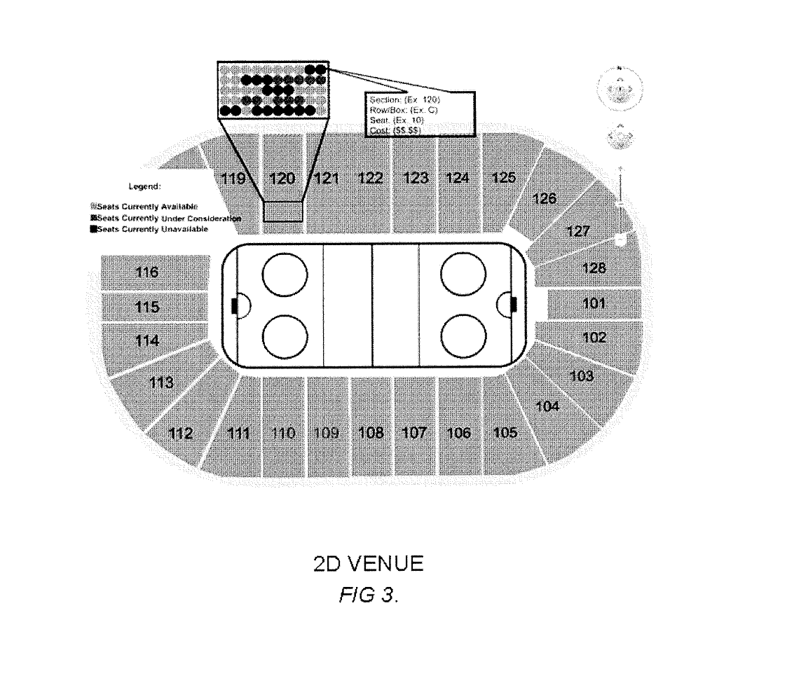

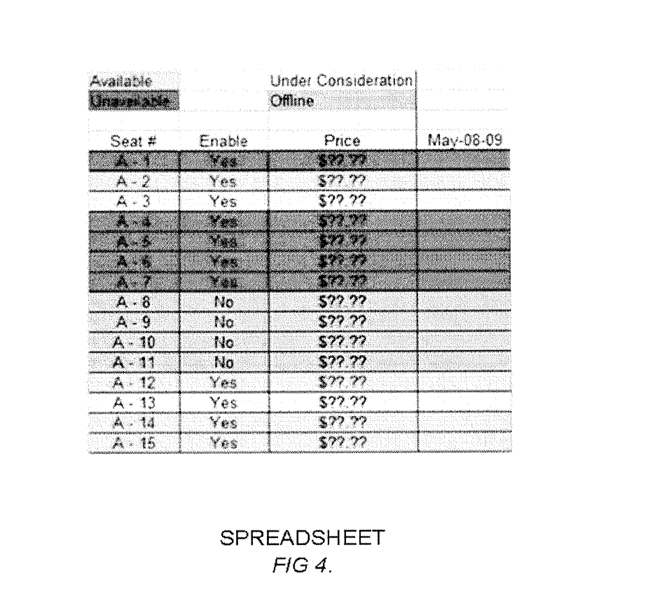

Referring to FIG. 1A through 1D, the preferred steps involved for “promoters”, or those entities seeking customers, are described. The flowchart sets out the relationship of each step to the others:
Step 102—FILL OUT ON-LINE FORM FOR CREATION OF ACCOUNT(S) (START). The promoters have the ability to fill out an on-line form for a creation of an account. Multiple accounts created if there are multiple promoters. An example is two promoters with in Maverick Records.
Step 104—AGREEMENT SIGNED BETWEEN PARTIES AND ACCOUNT(S) ARE THEN CREATED FOR THE PROMOTERS. The ticket distributor reviews the online forms along with making contact with the promoters. The ticket distributor then decides on whether the agreements are to take place between the parties. Once agreements have taken place, account(s) are then for created to the promoters.
Step 106—CONTACT TICKET DISTRIBUTOR. The promoters have the ability to communicate to the ticket distributor via Phone, E-Mail, and Mail etc at anytime.
Step 108—PROMOTERS SIGN INTO PORTAL (START). In order to launch the application the promoters must first sign into the portal with their received account credentials. The application is available to sign in to at anytime.
Step 110—CREATE NEW PROJECT NAME. The promoters have the ability to create new projects once inside portal. If the new project name conflicts with any previously created project names, the promoters are then notified to create a different project name. An example of such is the previously created Aerosmith's Just Push Play world tour of 01-02. The promoters are not able to create a further project with the same name.
Step 112—CHOOSE LANGUAGE. The promoters have the ability to change the language (if provided) that is more preferred.
Step 114—PRESENT PROJECT(S) LIST. The promoters have the ability to view the present project(s) list. An example is Michelle Branch and Alanis Morissette with Maverick Records.
Step 116—REMOVE PROJECT. The promoters have the ability to remove a project from the project(s) list.
Step 118—RENAME PROJECT. The promoters have the ability to rename the project before finalized by the ticket distributor. Once finalized the project name will be unchangeable. If the rename conflicts with any previously created project names, the promoters are then for notified to create a different project name.
Step 120—PRESENT PROJECT. The promoters have the ability to choose a project from the project(s) list. The project(s) are alphabetically organized. An example is the Alanis Morissette project with in the Maverick Records account.
Step 122—REMOVE VENUE(S). The promoters have the ability to remove venue(s) from the present project.
Step 124—ADD VENUE. The promoters have the ability to add a venue to the project from the query list.
Step 126—QUERY FOR VENUE. The promoters have the ability to run a query for venue(s). Thee queries are filtered by country, province/state, and city. The returned results display descending from largest seat capacity to smallest seat capacity. Once the query is completed and the venue(s) display, the promoters can choose the venue in obtaining further statistics. An example is Canada, Alberta, and Edmonton Rexall Centre. Statistics displayed are seating 17,000, divided into 9 levels, etc. The promoters also have the ability to upload their own 2D model so that developers at the ticket purchasing system can custom built their venue and/or event. An example is creating a 2D model of a one time seating arrangement in the hall where the ticket distributors can create seating arrangements in relation to the submitted 2D model. The promoter will not be able to continue on until the ticket distributor has created the 2D model.
Step 128—2D MODEL DISPLAY. The promoters have the ability to view the venue in a 2D model display, an example of which is shown in FIG. 3. When the model loads, it displays as a bird's eye view looking down in 2D. The promoters have the ability to zoom in and out as well be able to pan across the venue level. A compass displays on the model where promoters are able to rotate the venue level a complete 360 degrees. At anytime the promoters can double click on the compass and return to the point of origin where they once again see a bird's eye view of the venue level. The promoters can choose only one level at a time when viewing the model. The venue is descriptive enough that each seat is viewable. It is important to note that all seats display in the circular color grey because the model is currently for viewing purposes only. The promoters at anytime can choose between viewing the 2D or the 3D model.
Step 130—3D MODEL DISPLAY. The promoters have the ability to view the venue in a 3D model display. When the model loads, it is displays as a bird's eye view looking down in 3D. The promoters have the ability to zoom in and out as well be able to pan around the venue as if flying. A compass displays on the model where promoters are able to rotate the venue a complete 360 degrees. At anytime the promoters can double click on the compass and return to the point of origin where they once again see a bird's eye view of the venue. The venue is descriptive enough that each seat and the computer-generated person sitting in the seat are viewable. It is important to note that all seats display in the color grey because the model is currently for viewing purposes only. The promoters at anytime can choose between viewing the 2D or the 3D model.
Step 132—ADD TO PROJECT. The promoters when satisfied with the venue and its layout can add the project to the project list only if the venue has not already previously added. The promoters if not satisfied with the venue and its layout can return to the query.
Step 134—PRESENT VENUE. The promoters have the ability to view the list of venue(s) added to the project. The default views of the added venue(s) are largest to smallest seat capacity. Venue(s) already customized with Date(s) that are to happen display alongside the venue(s) in the color green. Venue(s) already customized with Date(s) that are cancelled display alongside the venue(s) in the color grey. Venue(s) already customized that have happened display alongside the venue(s) in the color red. Upon choosing the venue the following information displays, 2D/3D model chosen, Venue Layout chosen, Advertisement Name (if chosen), Ticket Sale Date(s) (if chosen), and Number of Seat(s) Enabled/Disabled. An example is Edmonton Rexall Centre and the Calgary Saddledome for the Alanis Morissette project.
Step 136—2D MODEL DISPLAY. The promoters have the ability to view the venue in a 2D model display, such as the example depicted in FIG. 3. When the model loads, it displays as a bird's eye view looking down in 2D. The promoters have the ability to zoom in and out as well be able to pan across the venue level. A compass displays on the model where promoters are able to rotate the venue level a complete 360 degrees. At anytime the promoters can double click on the compass and return to the point of origin where they once again see a bird's eye view of the venue level. The promoters can choose only one level at a time when viewing the model. The venue is descriptive enough that each seat is viewable. It is important to note that all seats display in the circular color grey because the model is currently for viewing purposes only. If the promoters have not yet customized the seat(s) layouts then all of the seats display in the color grey. The promoters can use this model as a reference at anytime before finalizing the completion of the customization process in the venue. The promoters at anytime can choose between viewing the 2D or the 3D model.
Step 138—3D MODEL DISPLAY. The promoters have the ability to view the venue in a 3D model display. When the model loads, it is displays as a bird's eye view looking down in 3D. The promoters have the ability to zoom in and out as well be able to pan around the venue as if flying. A compass displays on the model where promoters are able to rotate the venue a complete 360 degrees. At anytime the promoters can double click on the compass and return to the point of origin where they once again see a bird's eye view of the venue. The venue is descriptive enough that each seat and the computer-generated person sitting in the seat are viewable. It is important to note that all seats display in the color grey because the model is currently for viewing purposes only. If the promoters have not yet customized the seat(s) layouts then all of the seats display in the color grey. The promoters can use this model as a reference at anytime before finalizing the completion of the customization process to the venue. The promoters at anytime can choose between viewing the 2D or the 3D model.
Step 140—CUSTOMIZE ALL VENUE(S) WITHIN THE PROJECT. The promoters have the ability to apply settings to all venue(s) at one time whether added to the project or are going to be added.
Step 142—MODEL. The promoters have the ability to choose between the 2D or 3D model display for all venue(s) that the public customers will view at the time of sale. The configuration of venue(s) is never lost if the promoters switch between the two models. The models will have a different service charge attached to each seat.
Step 144—ADVERTISEMENT. The promoters have the ability to choose what type of advertisement will display for all of the venue(s). This option is only available if the promoters have chosen the 3D model. An example is the promoters choosing Edmonton Oilers from the team options list. A short preview of the team in action will display in the 3D model on center ice. Another example is the promoters choosing Aerosmith from the artist options list. A short preview of the band performing will display in the 3D model on center stage.
Step 146—ORGANIZE VENUE(S). The promoters have the ability to organize the list of venue(s) by country, province/state, city, date, seat capacity, or model.
Step 148—SEASON TICKETS. The promoters have the ability to apply season tickets to all of the venue(s). If the promoters include season tickets to the venue(s) two models are then for created. One model is for season tickets controlling all of the event(s) date(s) in each venue as one and another model is for the regular tickets controlling only one event date in each venue. The promoters will have to customize two models as well. When the public customer has chosen season tickets, the season tickets model is loaded controlling all of the event(s) date(s) in the venue. The regular tickets seat(s) appear grayed out indicating un-bookable. When the public customer has chosen regular tickets, the regular tickets model is loaded controlling only one event date in the venue. The season tickets seat(s) appear grayed out indicating un-bookable.
Step 150—NOTIFICATION DATE(S). The promoters have the ability to apply the same notification date to the public customer(s) for all of the event(s) date(s) at the venue(s), such as the example shown in FIG. 2. The promoters have the ability to apply the same amount of notification time between the ticket sale date(s) for each event(s) date(s) at the venue(s). An example is the World Wrestling Entertainment issuing a notification date three months prior to each ticket sale date(s) with in project.
Step 152—CUSTOMIZE VENUE. The promoters have the ability to customize a single venue model display. Upon choosing the venue, the following items display for customization, Date(s), 2D/3D model display, Venue Layout, Advertisement (if applicable), Ticket Sale Date(s), and Number of Seat(s) Enabled/Disabled.
Step 154—DATE(S). The promoters have the ability to choose the date(s) to host their event at the venue, such as the example shown in FIG. 2. The promoters will be able to choose the date(s) via calendar display. The promoters have three colors present indicating the status of each date, Green as available, Yellow as under consideration, Red as unavailable, and Grey as un-bookable.
Step 156—MODEL. The promoters have the ability to choose between the 2D or 3D model display for the venue that the public customers will view at the time of sale, an example of which is shown in FIG. 3. If the promoters has previously chosen settings with the “customize all venue”, the model settings will be inherited by that. Even though the settings has been inherited by the “customize all venue”, the promoters still have the option of changing it. The configuration is never lost if the promoters switch between the models. The models will have a different service charge attached to each seat.
Step 158—STAGE LAYOUT. The promoters have the ability to choose a pre-laid out stage layout. An example is the promoters having the venue as a hockey arena with ice in the center. Another example is the promoters having the venue as a center stage with no ice and seating on the main floor.
Step 160—ADVERTISEMENT. The promoters have the ability to choose what advertisement displays for the venue. This option is only available if the 3D model is chosen. An example is the promoters are choosing Edmonton Oilers from the team options list. A short preview of the team in action displays in the 3D model on center ice. Another example is the promoters are choosing Aerosmith from the artist options list. A short preview of the band in action displays in the 3D model on center stage. If the promoters have previously chosen settings with the “customize all venue”, the model settings will be inherited by that.
Step 162—TICKET SALE DATE(S). The promoters have the ability to choose the date(s) the tickets will go on sale for the event(s) at that venue, such as the example shown in FIG. 2. An example is the promoters choosing May 28, 2009 as the date for tickets to go on sale for an event-taking place in a few months. If the promoters have more then one date set at the venue, they can choose multiple dates for ticket sales.
Step 164—SEASON TICKETS. The promoters have the ability to apply season tickets for the venue. If the promoters include season tickets to the venue two models are then for created. One model is for season tickets controlling all of the event(s) date(s) in the venue as one and another model is for the regular tickets controlling only one event date in the venue. The promoters will have to customize two models as well. When the public customer has chosen season tickets, the season tickets model is loaded controlling all of the event(s) date(s) in the venue. The regular tickets seat(s) appear grayed out indicating un-bookable. When the public customer has chosen regular tickets, the regular tickets model is loaded controlling only one event date in the venue. The season tickets seat(s) appear grayed out indicating un-bookable.
Step 166—NOTIFICATION DATE(S). The promoters have the ability to apply the notification date(s) to the public customer(s) for the event(s) at the venue, as shown in FIG. 2.
Step 168—SEAT(S). The promoters have the ability to enable or disable or obtain pre-paid seat(s) for friends and family with in the venue after choosing the venue layout. The promoters can either enable or disable or obtain pre-paid seat(s) from the 2D or the 3D model displays, or by a spreadsheet system that displays each seat, examples of which are shown in FIG. 2 and FIG. 4. This will determine what seat(s) are available for the public customer to be able to purchase at the time of sale. By default all the seat(s) are enabled and represented by the color green allowing public customers to purchase them. Upon disabling seat(s) the status of the seat(s) will change from green to grey indicating to the public customer they will never be available for purchase.
Step 170—SEAT(S) PRICES. The promoters have the ability to price individual seat(s)/row(s)/section(s). The promoters will be able to control click on each individual seat indicating its price. The promoters will also have the ability to issue discounts when indicating the seat(s) price. An example is making a row of seats(s) twenty dollars but if the public customer selects more then five seats, they are issued a ten percent discount. Seat(s) that have prices indicated to them will turn from clear to green on the 2D/3D model.
Step 172—TICKET AND BUTTON DESIGN. The promoters have the ability to choose or design their own ticket and button for the project. The promoters must select the date(s) of the event prior to designing the ticket and button.
Step 174—CREATE BUTTON DESIGN. The promoters have the ability to create a button design by either a “pre-laid out button design” or a “customize button design” before finalizing the project. The ticket distributor will decide whether the design is appropriate upon the finalization request.
Step 176—PRE-LAID OUT BUTTON DESIGN. The promoters have the ability to choose from anyone of the pre-laid out button designs before finalizing the project. This options used if they decide not to use the default button design or the custom button design.
Step 178—CUSTOMIZE BUTTON DESIGN. The promoters have the ability to custom design their button by uploading their image before finalizing the project. This options used if they decide not to use the default button design or the pre-laid out button design.
Step 180—CREATE TICKET DESIGN. The promoters have the ability to create a ticket design by either a “pre-laid out ticket design” or a “customize ticket design” before finalizing the project. The ticket distributor will decide whether the design is appropriate upon the finalization request.
Step 182—PRE-LAID OUT TICKET DESIGN. The promoters have the ability to choose from anyone of the pre-laid out ticket designs before finalizing the project. This options used if they decide not to use the default ticket design or the custom ticket design.
Step 184—CUSTOMIZE TICKET DESIGN. The promoters have the ability to custom design their ticket by uploading their image before finalizing the project. This options used if they decide not to use the default ticket design or the pre-laid out ticket design.
Step 186—TICKET DISTRIBUTOR COMMUNICATION. The promoters have the ability to communicate with the ticket distributor on the progress prior and after the finalization of the project.
Step 188—FINALIZE PROJECT. The promoters have the ability to submit their finished project to the ticket distributor to overlook and either approve or object the project. The promoters will have a checkmark and a box to enter information about any changes made to the prior finalized project. An example is the promoter adding an extra date of Ron James to a venue. The project is then for finalized upon the ticket distributor's approval.
Step 190—TICKET DISTRIBUTOR REMOVE EVENT(S) DATE(S). The promoters have the ability to remove the event(s) date(s) after the ticket sales are available at the venue. An example is a catastrophic unforeseen incident where the event(s) date(s) need to be removed. The promoters have the ability to choose whether they want to send letters to their ticket customers of the event(s) date(s) removed. The ticket distributor must either approve or object before the finalization occurs. If the ticket distributor objects the proposal of a remove, the promoters will have to make the appropriate changes before resubmitting for a finalization.
Step 192—TICKET DISTRIBUTOR RESCHEDULE EVENT(S) DATE(S). The promoters have the ability to reschedule the event(s) date(s) after the ticket sales are available at the venue, as depicted in FIG. 2. An example is a catastrophic unforeseen incident where the event(s) date(s) would need to be rescheduled. The promoters have the ability to choose whether they want to send letters to their ticket customers of the event(s) date(s). The ticket distributor must either approve or object before the finalization occurs. If the ticket distributor objects the proposal of a reschedule, the promoters will have to make the appropriate changes before resubmitting for a finalization.
Step 194—SETTINGS AFTER THE PUBLIC AND TICKET DISTRIBUTOR NOTIFIED. The promoters have the ability to change settings to the event(s) date(s) after the finalization of the project by the ticket distributor and the tickets are available for purchase.
Step 196—RESCHEDULE EVENT(S). The promoters have the ability to reschedule the event(s) date(s) after the finalization of the project by the ticket distributor when the tickets are available for purchase, as depicted in FIG. 2.
Step 198—REMOVE EVENT(S). The promoters have the ability to remove the event(s) date(s) after the finalization of the project by the ticket distributor when the tickets are available for purchase.
Step 200—PAST PROJECT(S). The promoters have the ability to view any of the past project(s) that are completely completed.
Step 202—QUERY FOR PAST PROJECT, VENUE, EVENT, DATE, COUNTRY, PROVINCE/STATE AND CITY. The promoters have the ability to query for a past Project, Venue, Date, Country, Province/State and City. All of the returned results display alphabetically descending from a to z. Once the query is completed and venue(s) display, the promoters can choose the venue in obtaining further statistics. An example is Canada, Alberta, and Edmonton Rexall Centre. Statistics displayed are seating 17,000, divided into 9 levels, etc.
Step 204—EXPORT TO ACCOUNTING SOFTWARE. The promoters have the ability to export past project(s), venue(s) or event(s) information to third party accounting software.
Step 206—PRINT INFORMATION. The promoters have the ability to print revenue information about the past project(s), venue(s) or event(s).
Step 208—REMOVE PROJECT(S). The promoters have the ability to remove past project(s) from the project(s) list.
Step 210—REMOVE VENUE. The promoters have the ability to remove venue(s) from the past venue(s) list.
Step 212—SIGN OUT (FINISH). The promoters have the ability to sign out of the ticket distributor's website.

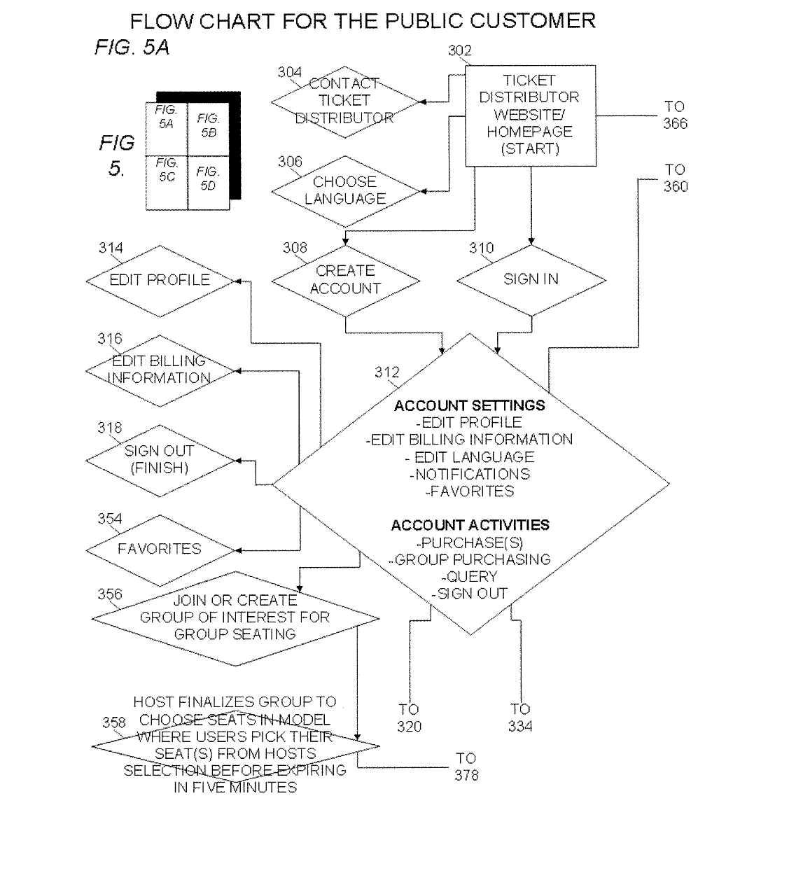

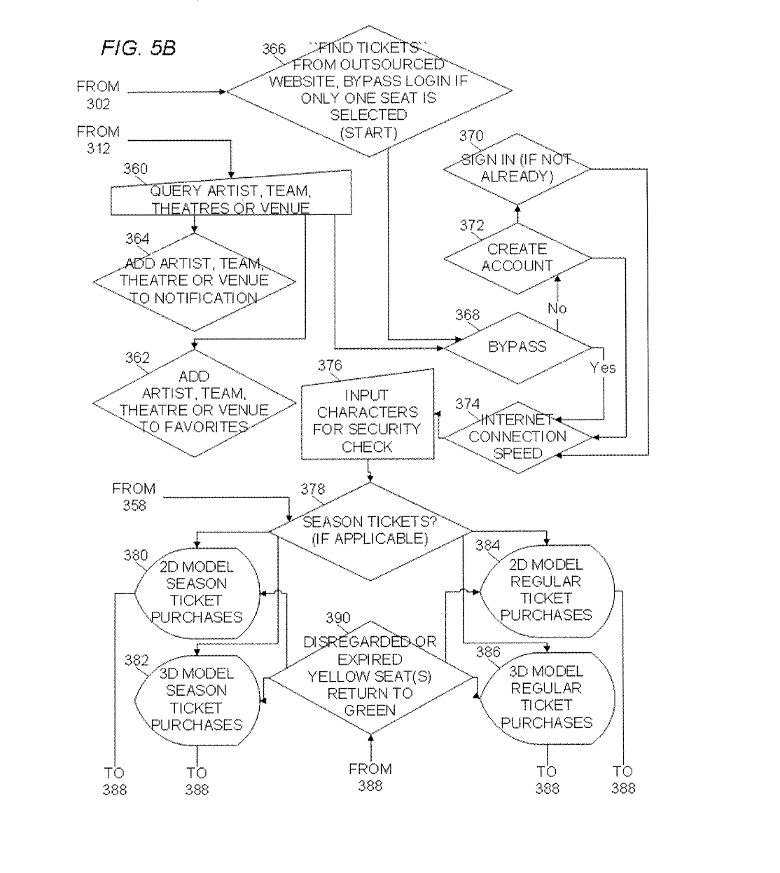

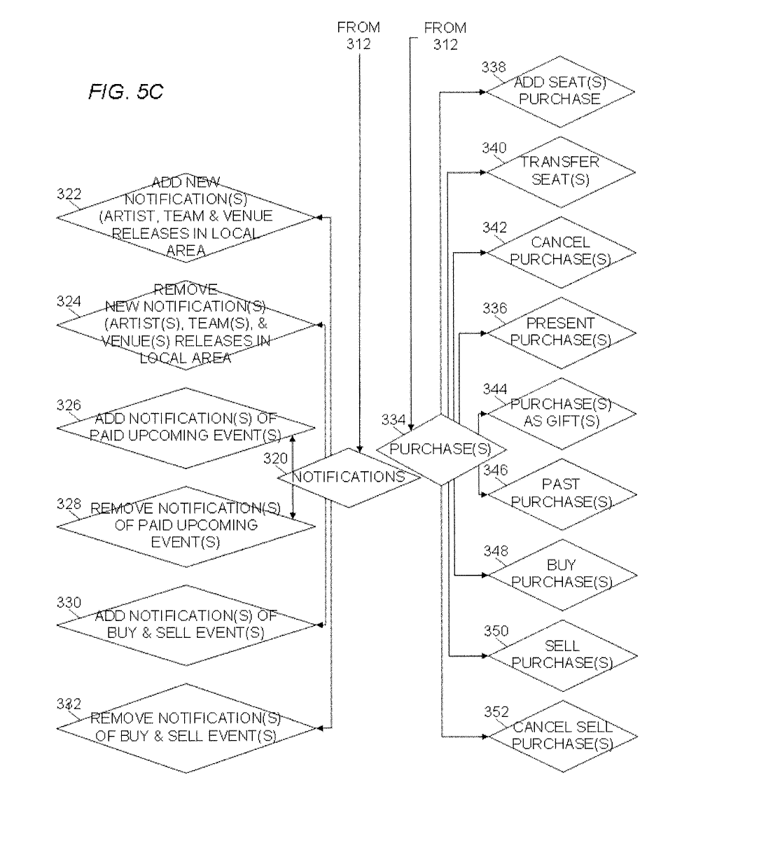

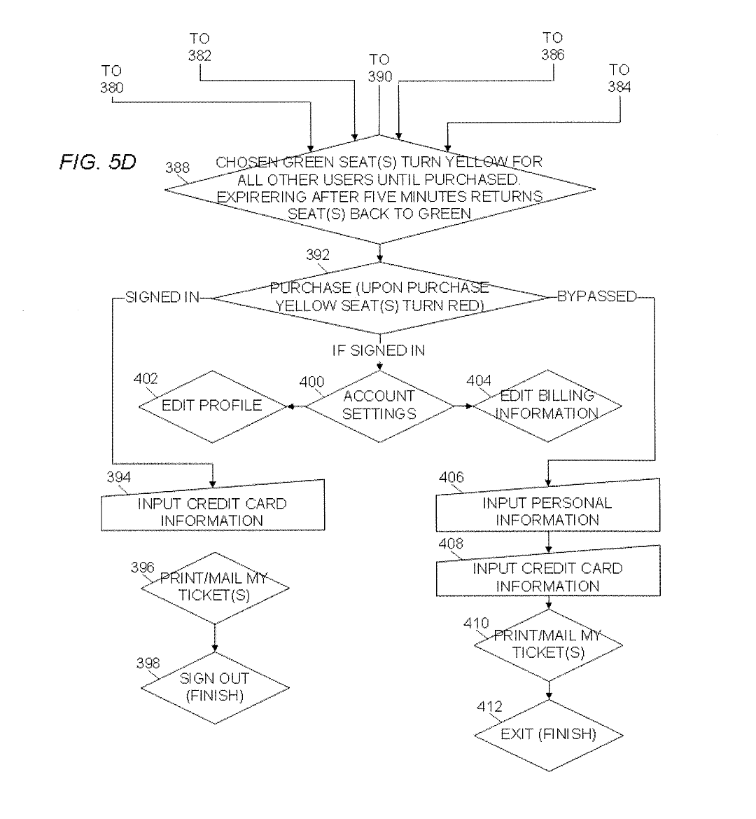

Referring to FIG. 5A through 5D, there will be described of the steps involved for the customers, or those entities seeking the services of the promoters:
Step 302—TICKET DISTRIBUTOR WEBSITE/HOMEPAGE (START). The public customer has the ability to visit the ticket distributor's website where array of options are available.
Step 304—CONTACT TICKET DISTRIBUTOR. The public customer has the ability to view the contact information to the ticket distributor via displaying Phone, E-Mail, and Mail etc.
Step 306—CHOOSE LANGUAGE. The public customer has the ability to change the language (if provided) that is more preferred.
Step 308—CREATE ACCOUNT. The public customer has the ability to create an on-line account in the ticket distributor's website. Create an account will require the public customer to input the specific information about themselves such as First Name, Last Name, E-Mail, Age (must be accompanied by an adult if under eighteen), Username, Password, Country, Province/State, and Postal Code/Zip Code etc.
Step 310—SIGN IN. The public customer has the ability to sign in to their account.
Step 312—ACCOUNT SETTINGS/ACCOUNT ACTIVITIES. The public customer has the ability to view and edit multiple settings with in their account. Settings such as Notifications, Edit Profile, Edit Billing Information, Favorites, Purchase(s), Group Purchasing, Query, and Sign Out etc.
Step 314—EDIT PROFILE. The public customer has the ability to view and edit the information regarding their profile.
Step 316—EDIT BILLING INFORMATION. The public customer has the ability to view and edit the information regarding their billing.
Step 318—SIGN OUT (FINISH). The public customer has the ability to Sign Out of their account in the ticket distributor's website.
Step 320—NOTIFICATIONS. The public customer has the ability to add or remove a variety of notifications pertaining to Artist(s), Team(s) and Venue(s) releases in a local area, Paid Upcoming Events along with Buying and Selling of Seat(s) at Event(s).
Step 322—ADD NEW NOTIFICATION(S) (ARTIST, TEAM, AND VENUE RELEASES IN LOCAL AREA). The public customer has the ability to query an Artist, Team; Venue releases in a local area and add such so that a notification is sent via SMS, E-Mail, and Phone Message. An example is the public customer wanting to receive a notification via E-Mail only of when Aerosmith is performing in their local area. The ticket distributor will send an E-Mail prior to the ticket sale date.
Step 324—REMOVE NEW NOTIFICATION(S) (ARTIST(S), TEAM(S), AND VENUE(S) RELEASES IN LOCAL AREA). The public customer has the ability to view their new notification(s) list and remove any unwanted SMS, E-Mail, and Phone Messages from the list. An example is the public customer not wanting to receive a notification any longer via SMS of when Aerosmith is performing in their local area but still receive a notification via E-Mail. The ticket distributor will send an E-Mail prior to the ticket sale date.
Step 326—ADD NOTIFICATION(S) OF PAID UPCOMING EVENT(S). The public customer has the ability to view and add their paid upcoming event(s) to the notification(s) list and choose the date(s) to receive these notification(s). The options available to receive the notification(s) are via SMS, E-Mail, and Phone Message. An example is the public customer wanting an E-Mail notification a week prior to the concert and two days before via SMS.
Step 328—REMOVE NOTIFICATION(S) OF PAID UPCOMING EVENT(S). The public customer has the ability to view and remove their paid upcoming event(s) from the notification(s) list. The options available to remove the notification(s) are via SMS, E-Mail, and Phone Message. An example is the public customer not wanting an E-Mail notification a week prior to the concert but still two days before via SMS.
Step 330—ADD NOTIFICATION(S) OF BUY AND SELL EVENTS(S). The public customer has the ability to add notification(s) of any cancellation(s) and/or sales of an event made by another public customer. The options to receive the notification(s) are via SMS, E-Mail, and Phone Message. An example is a sold old event where a public customer has added a notification(s) if other public customer purchasers have cancelled or are selling their purchase(s).
Step 332—REMOVE NOTIFICATION(S) of BUY AND SELL EVENT(S). The public customer has the ability to remove notification(s) of any cancellation(s) and/or sales of an event made by another public customer. The options to remove the notification(s) are via SMS, E-Mail, and Phone Message. An example is a sold out event where a public customer no longer wants to receive a notification(s) if other public customer purchasers have cancelled or are selling their purchase(s).
Step 334—PURCHASE(S). The public customer has the ability to view their Present Purchase(s), Add, and Transfer or possibly Cancel their present purchase(s), send Purchase(s) as Gift(s), view Past Purchase(s), Buy Purchase(s), Sell Purchase(s), and Cancel Sell Purchase(s).
Step 336—PRESENT PURCHASE(S). The public customer has the ability to view their Present Purchase(s) and be able to print their purchase(s). Each ticket comes with a barcode and reference number that needs to be confirmed by a scanner at the event entrance.
Step 338—ADD SEAT(S). The public customer has the ability to add additional seat(s) with in the purchased event. An example is if the public customer has already purchased an event only to find out later that acquaintance(s) would like to join allowing the public customer to add further seat(s).
Step 340—TRANSFER SEAT(S). The public customer has the ability to transfer seat(s) with in the purchased event. Once seat(s) successfully transfers other public customers have the ability to purchase or transfer to it and adjust appropriate funds. An example is if the public customer has already made purchase(s) to an event, only to find out later that there are better seat(s) available. The public customer has the ability to transfer seat(s) to the better seat(s) available and pay more.
Step 342—CANCEL PURCHASE(S). The public customer has the ability to cancel seat(s) with in the purchased event depending whether the ticket distributor has approved public customers cancellation. Once a seat(s) successfully cancels, other public customers have the ability to purchase or transfer to it.
Step 344—PURCHASE(S) AS GIFT(S). The public customer has the ability to purchase seat(s) as gift(s) for other acquaintance(s). The public customer after purchasing the seat(s) will be required to input the receiver(s) E-Mail, Mail Address along with a message if desired. An example is a parent purchasing seats for their child's birthday where they will be able to take a friend. The parents are able to send the E-Mail, Mail Address on their child's birthday along with a message included if desired. If the child does not already have an account with the ticket distributor, then they will be required to create one before receiving the purchase(s).
Step 346—PAST PURCHASE(S). The public customer has the ability to view their Past Purchase(s) and print off the information regarding it.
Step 348—BUY PURCHASE(S). The public customer has the ability to buy another public customers purchase(s) if posted to sell.
Step 350—SELL PURCHASE(S). The public customer has the ability to sell their purchase(s) to other public customers resulting in being cheaper then simply cancelling their purchase(s).
Step 352—CANCEL SELL PURCHASE(S). The public customer has the ability to cancel their posted selling purchase(s) resulting in being more expensive then simply selling their purchase(s). An example is if the public customer decides not to sell their purchase(s) before another public customer purchase(s), they can cancel posting them for others to purchase.
Step 354—FAVORITES. The public customer has the ability to add or remove from their Favorites list Venue(s), Artist(s), and Team(s).
Step 356—JOIN OR CREATE GROUP OF INTEREST FOR GROUP SEATING. The public customer has the ability to either be a host or a guest to a group purchasing of an event. The Host will first create the Group and choose the event (must be added to their Favorites list), Name the Group along with creating a Password for the Guest(s) to join. It will be the responsibility of the group parties to communicate with each other. After creating the Group, the Host and Guest(s) will choose the number of seat(s) they each want to purchase. Upon choosing the number of seats and viewing all group members joined, the host has the ability to remove any unwanted Guest(s) from the Group before finalizing the Group. The Guest will be able to view a list of Group(s) available along with the event that it is associated with it. It will be the responsibility of the group parties to communicate with each other. The Guest then is required to enter a Password before being able to join the Group. After joining, the Guest is required to choose the number of seat(s) wanting to purchase. The guest is then able to view the host finalize the Group.
Step 358—HOST FINALIZES GROUP TO CHOOSE SEATS IN MODEL WHERE USERS PICK THEIR SEAT(S) FROM HOSTS SELECTION BEFORE EXPIRING IN FIVE MINUTES. Upon the Finalization of the Group, all members are directed to the event and the Host chooses the available seating arrangements for themselves and Guests, Guests remain unable to choose any seat(s) but can view the venue. Once Host has chosen all seats Guests are brought in to the Hosts selection and choose their seat(s). Each Guest and Host internet connection speed is automatically detected and expiration of time starts when each Guest is brought in to their seat(s) selection.
Step 360—QUERY ARTIST, TEAM, THEATRE OR VENUE. The public customer has the ability to query for an event either by Artist, Team, Theatre or Venue. The result(s) of the query will be displayed for the public customer to see.
Step 362—ADD ARTIST, TEAM, THEATRE OR VENUE TO FAVORITES. The public customer has the ability to add the query result(s) to their favorites list.
Step 364—ADD ARTIST, TEAM, THEATRE OR VENUE TO NOTIFICATION. The public customer has the ability to query an Artist, Team, Venue releases in a local area and add such so that a notification is sent via SMS, E-Mail or Phone Message. An example is the public customer wanting to receive a notification via E-Mail only of when Aerosmith is performing in their local area. The ticket distributor will send an E-Mail prior to the ticket sale date.
Step 366—“FIND TICKETS” FROM OUTSOURCED WEBSITE, BYPASS LOGIN IF ONLY TWO SEATS ARE SELECTED (START). The public customer has the ability to visit the actual events website and click a link to find tickets. The link will re-direct them to the ticket distributer's website where they will be able to bypass the login if they are purchasing two tickets or less. If more then two tickets are wanted for purchase, the public customer will be required to sign in.
Step 368—BYPASS. The public customer has the ability to bypass the sign in section if they are only looking at purchasing two tickets and do not have an account created.
Step 370—SIGN IN. The public customer has the ability to sign in to their account.
Step 372—CREATE ACCOUNT. The public customer has the ability to create an on-line account on the ticket distributor's website. Creating an account will require the public customer to input the specific information about themselves such as First Name, Last Name, E-Mail, Age (must be accompanied by an adult if under eighteen), Username, Password, Country, Province/State, and Postal Code/Zip Code etc.
Step 374—INTERNET CONNECTION SPEED. The public customer internet connection speed is automatically detected informing the server of the public customers internet connection speed for refresh rates. Since the download speed can only be as fast as the receiving ends upload speed, it is important that users with slower connection speeds (such as dial up) be redirected through a different pipeline to sustain performance for everyone. The public customer with a slower internet connection speed has less visual quality due to the fast accurate seat information. The public customer with a faster internet connection speed has higher visual quality and fast accurate seat information.
Step 376—INPUT CHARACTERS FOR SECURITY CHECK. The public customer has the ability to input a series of characters as a security check prior to loading the model. The public customer must enter characters that randomly generate by the server. The point of this check is to prove that the entity trying to gain access to the site is in fact human and not a programmed bot or spider.
Step 378—SEASON TICKETS? (IF APPLICABLE). The public customer has the ability to choose whether they want season ticket(s). This option is only applicable to sporting events.
Step 380—2D MODEL SEASON TICKET PURCHASES. The public customer has the ability to select their season ticket seat(s) from the 2D model of the venue. The public customer will only view the 2D model if chosen prior by the promoter(s). The public customer can choose a variety of options to narrow down their selection. Such options include Select Language, Date of Event, Price Range, Number of Seats Chosen, Level of Seating, Best Available, and being able to search for a seat by section or row etc.
Step 382—3D MODEL SEASON TICKET PURCHASES. The public customer has the ability to select their season ticket seats from the 3D model of the venue. The public customer will only view the 3D model if chosen prior by the promoter(s). The public customer can choose a variety of options to narrow down their selection. Such options include Select Language, Date of Event, Price Range, Number of Seats Chosen, and Level of seating as well as being able to search for a seat by section or row. The 3D model displays a legend with selectable items such as Entrances/Exits, Washrooms, Drinking Fountains, Snack Machines, Food Stands, Elevators, Stairs, and Handicap Accessible Seats etc. When an item is selected, the location(s) will flash on the 3D model.
Step 384—2D MODEL REGULAR TICKET PURCHASES. The public customer has the ability to select their regular seats from the 2D model of the venue. The public customer will only view the 2D model if chosen prior by the promoter(s). The public customer can choose a variety of options to narrow down their selection. Such options include Select Language, Date of Event, Price Range, Number of Seats Chosen, Level of Seating, Best Available, and being able to search for a seat by section or row etc.
Step 386—3D MODEL REGULAR TICKET PURCHASES. The public customer has the ability to select their regular seats from the 3D model of the venue. The public customer will only view the 3D model if chosen by the promoter(s). The public customer can choose a variety of options to narrow down their selection. Such options include Select Language, Date of Event, Price Range, Number of Seats Chosen, Level of seating, Best Available, and being able to search for a seat by section or row etc. The 3D model displays with selectable items such as Entrances/Exits, Washrooms, Drinking Fountains, Snack Machines, Food Stands, Elevators, Stairs, Handicap Accessible Seats and more. When an item is selected, the location(s) will flash on the 3D model.
Step 388—CHOSEN GREEN SEAT(S) TURN YELLOW FOR ALL OTHER USERS UNTIL PURCHASED. EXPIRERING AFTER FIVE MINUTES RETURNS SEAT(S) BACK TO GREEN. The public customer has the ability to select any seat(s) of interest that display in the color green on the model. The public customer can select more then one seat by holding down a designated key while selecting the seat(s). Upon selecting a green colored seat(s) the status changes to yellow indicating to other public customer(s) that the seat(s) are under consideration by another public customer. The public customer cannot select yellow or red seat(s) within the event.
Step 390—DISREGARDED OR EXPIRED YELLOW SEAT(S) RETURN TO
GREEN. The public customer has the ability to disregard their selected seat(s) and look at selecting another. If the public customer has not made a decision before the reservation time expires, the system will automatically disregard the seat(s), returning the status from yellow back to green.
Step 392—PURCHASE (UPON PURCHASE YELLOW SEAT(S) TURN RED). The public customer has the ability to purchase their selected seat(s). If not with an account, they will be forwarded to a purchase order form where they will be required to input the appropriate information in order for the transaction to occur. If they do have an account, their stored required information will be verified by them in order for the transaction to occur. The public customer reserved length of time is extended if they choose to purchase the seat(s). Upon purchase, the selected seat(s) turn from yellow to red indicating to all other public customers that this seat(s) is unavailable.
   Step 394—INPUT CREDIT CARD INFORMATION. The public customer is required to input their credit card information in order to purchase seat(s).
Step 396—PRINT/MAIL MY TICKET(S). The public customer has the ability to print and/or have their ticket(s) mailed to them upon purchase.
Step 398—SIGN OUT (FINISH). The public customer has the ability to sign out of the ticket distributor's website.
Step 400—ACCOUNT SETTINGS. The public customer has the ability to change their account settings prior to finalizing any ticket purchases. An example would be if the public customer would like to be notified of the event they are about to purchase a week before it occurs.
Step 402—EDIT PROFILE. The public customer has the ability to change their profile information prior to finalizing any ticket purchases. An example would be if the public customer has just moved. They can update their account with the new address.
Step 404—EDIT BILLING INFORMATION. The public customer has the ability to change their billing information prior to finalizing any ticket purchases.
Step 406—INPUT PERSONAL INFORMATION. The public customer is required to input their personal information in order to purchase seat(s).
Step 408—INPUT CREDIT CARD INFORMATION. The public customer is required to input their credit card information in order to purchase seat(s).
Step 410—PRINT/MAIL MY TICKET(S). The public customer has the ability to print and/or have their ticket(s) mailed to them upon purchase.
Step 412—EXIT (FINISH). The public customer has the ability to exit the ticket distributor's website upon purchasing their ticket(s).

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1-8. (canceled)

9. An online reservation system with a server connected to a network having a database storing reservation information for reservable resources, the reservation information comprising time, location, pricing and reservation status, the reservation status listing the resources as being “unreserved” or “reserved”,
a user interface accessible by multiple users over the network for viewing the reservation status of the resources, submitting queries and receiving responses and a payment system for effecting payments,
wherein:
a transient reservation status of “pending” having an associated time limit, an inquiry on a specific one of the resources via the user interface by a user triggering the pending status for the specific one of the resources and blocking other users from reserving the specific one of the resources for the associated time limit, the pending status being visible to the other users through the user interface, the reservation status of the specific one of the resources being updated to “reserved” if payment is effected within the associated time limit and the reservation status of the specific one of the resources being updated to “unreserved” if payment is not effected within the associated time limit.

10. The online reservation system of claim 9, wherein the reservation status includes a reservation status of “unavailable” for any of the resources that are unavailable for reservation through the user interface.

11. The online reservation system of claim 9, wherein the reservation status includes a reservation status of “group block” listing resources that are allocated to a specific group, the resources of the group block being only available for reservation through the user interface to authorized members of the specific group.

12. The online reservation system of claim 9, wherein the time limit associated with the “pending” status is displayed on the user interface.

13. A method for making online reservations of reservable resources in an online reservation system with a server connected to a network having a database storing reservation information for reservable resources, the reservation information comprising time, location, pricing and reservation status, the reservation status listing the resources as being “unreserved” or “reserved”, a user interface for submitting queries and receiving responses and a payment system for effecting payments, the method comprising the steps of:
triggering a transient reservation status of “pending” having an associated time limit when an inquiry on a specific one of the resources is made via the user interface, the pending status being visible through the user interface and blocking other users from reserving the specific one of the resources;
updating the reservation status of the specific one of the resources to “reserved” if payment is effected within the associated time limit; and
updating the reservation status of the specific one of the resources to “unreserved” if payment is not effected within the associated time limit.

14. The method of claim 13, wherein the reservation status includes a reservation status of “unavailable” for any of the resources that are unavailable for reservation through the user interface.

15. The method of claim 13, wherein the reservation status includes a reservation status of “group block” listing resources that are allocated to a specific group, the resources of the group block being only available for reservation through the user interface to authorized members of the specific group.

16. The method of claim 13, wherein the time limit associated with the “pending” status is displayed on the user interface.
